(19) United States
(12) Patent Application Publication
(10) Pub. No.: US 2005/0055407 A1
(43) Pub. Date: Mar. 10, 2005

(54) Low earth orbit communication system

(75) Inventors: John Tandler, Oak Hill, VA (US); Thomas Michaud, Chantilly, VA (US)

Correspondence Address: Mr. John Tandler;Chief Executive Officer, SkyMate, Inc., P.O. Box 710357, Oak Hill, VA, 20171, US

(73) Assignee: SkyMate, Inc.

(21) Appl. No.: 10/658,129

(22) Filed: Sep. 9, 2003

(51) Int. Cl. G06F 15/16

(52) U.S. Cl. 709/206

(57) ABSTRACT

A method for sending email from a remote location. The method includes generating an electronic mail message using a personal computing device, transferring the electronic mail to a satellite data communicator configured to provide communication with a low earth orbiting satellite, and sending the electronic message to a low earth orbiting satellite using the satellite data communicator and an antenna coupled to the satellite data communicator.

### FIELD OF THE INVENTION

The present disclosure generally relates to the application of a low earth orbiting (LEO) satellite system to provide data services to individuals in remote areas. Specifically, the disclosure describes a mobile client communicating to an application server over a LEO satellite system.

### BACKGROUND

Individuals traveling to remote areas, whether in terrestrial vehicles or in maritime vessels, may not have access to traditional telecommunication systems. Additionally their communication needs may not be satisfied by remote communication systems. For example, long range voice radios are often used in remote areas but are expensive and require large antennas that are often too bulky for installation on personal vehicles and watercraft. Additionally, such long range radios require significant amounts of electrical power that is not always readily available.

Another remote communication system uses geostationary satellites, wherein the communication system is either very bulky and has too little throughput to be useful. Additionally, geostationary satellite terminals are generally too expensive for personal use. Further, such terminals with fixed geostationary antennas do not have sufficient bandwidth to serve most personal communications needs.

Yet another system uses low earth orbit satellites to provide data services to people in remote areas, but the services are incomplete and of limited utility. For example, data must often be transferred and received in a raw form.

What is needed is a communication system that provides both inexpensive equipment and low transmission expense. What is further needed is such a system that has been configured to provide information that is tailored to a receiver position. What is further needed is such a system that has been configured to optimize transmissions to maximize utility and reduce size of both the transmissions and the equipment.

The teachings hereinbelow extend to those embodiments which fall within the scope of the appended claims, regardless of whether they accomplish one or more of the above-mentioned needs.

### SUMMARY

One exemplary embodiment relates to a method for sending email from a remote location. The method includes generating an electronic mail message using a personal computing device, transferring the electronic mail to a satellite data communicator configured to provide communication with a low earth orbiting satellite, and sending the electronic message to a low earth orbiting satellite using the satellite data communicator and an antenna coupled to the satellite data communicator.

Another exemplary embodiment relates to a system for providing information to a user in a remote location. The system includes a communicator that includes a personal computing device, a satellite data communicator, and an antenna. The system further includes an application server system, wherein the application server system is configured to send and receive email with the communicator through a low earth orbit satellite system.

Yet another exemplary embodiment relates to a system for providing information to a user in a remote location. The system includes a communicator means configured to transmit and receive electronic mail over a low-earth orbiting satellite system from a remote location and an application server means configured to perform an action based upon the contents of an electronic mail message received from the communicator means.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a block diagram illustrating a low earth orbiting (LEO) communication system, according to an exemplary embodiment;

FIG. 2A depicts a flowchart illustrating methods for sending information using the LEO communication system shown in FIG. 1, according to an exemplary embodiment;

FIG. 2B depicts a flowchart illustrating methods for receiving information using the LEO communication system shown in FIG. 1, according to an exemplary embodiment;

FIG. 3 is a flowchart 300 illustrating a method of receiving updated text weather information based on current position using the LEO communication system shown in FIG. 1, according to an exemplary embodiment;

FIG. 4 is a flowchart illustrating a method for automatically providing position reports using the LEO communication system shown in FIG. 1, according to an exemplary embodiment; and

FIG. 5 is a flowchart 500 illustrating a method for transmitting a voice or facsimile message to a remote user using the LEO communication system shown in FIG. 1, according to an exemplary embodiment.

### DETAILED DESCRIPTION OF EXEMPLARY EMBODIMENTS

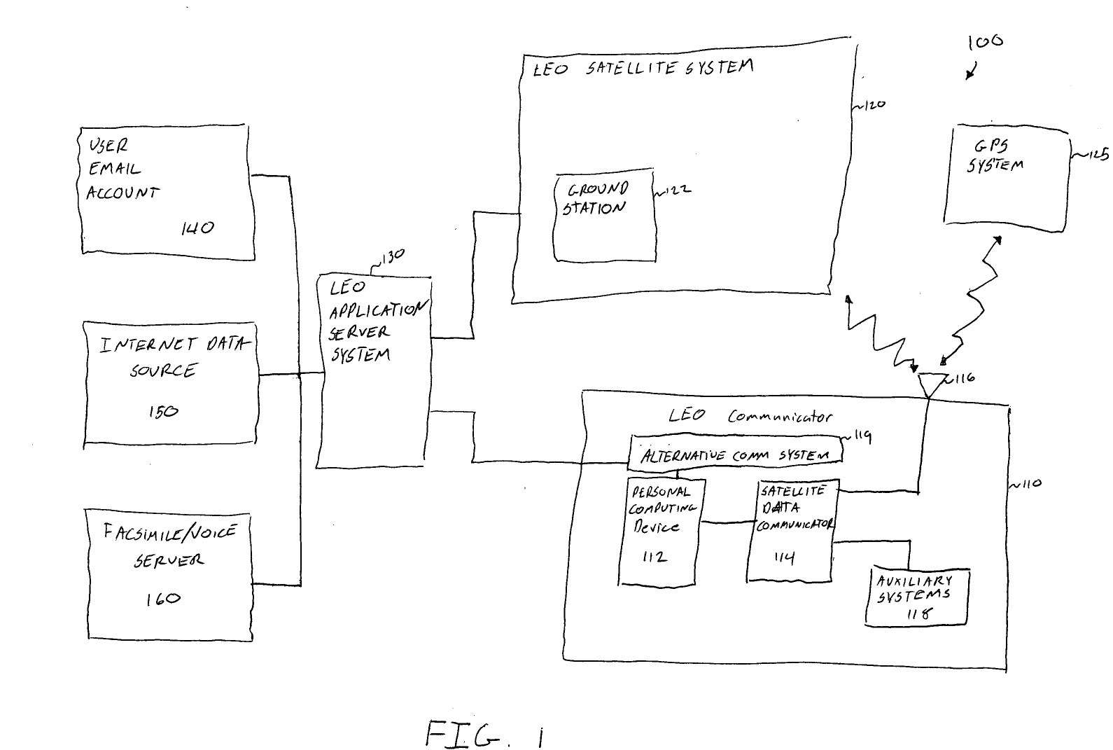

Referring to FIG. 1, a block diagram is provided illustrating a low earth orbiting (LEO) communication system 100 according to an exemplary embodiment. LEO communication system 100 includes an LEO communicator 110, an LEO satellite system 120, and an LEO application server system 130. LEO communicator 110 is configured to communicate through LEO satellite system 120 with LEO application server system 130.

According to the exemplary embodiment, a user traveling to a remote area may equip their mode of transportation (transportation mode) with LEO communicator 110 configured to operate within LEO communication system 100. The transportation mode may be any type of vessel or vehicle such as a terrestrial vehicle, a maritime vessel, an aircraft, etc. Alternatively, although a vessel or vehicle is described herein, LEO communicator 110 may alternatively be carried by the user independent of the vehicle, vessel, or mode of transportation.

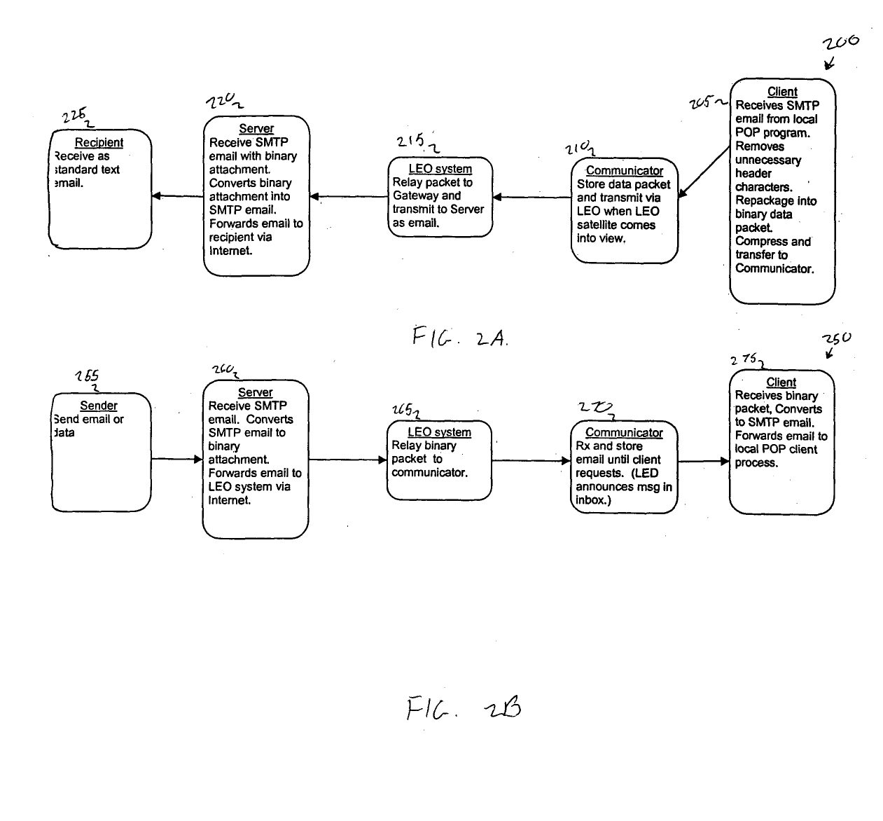

Advantageously, LEO communication system 100 may be used to provide communication services to the user even while a user is remotely located from traditional communication networks. Exemplary services, further described below with reference to FIGS. 2-5, may include sending and receiving email messages, sending text messages which are delivered in the form of voice messages, sending text messages that are delivered as fax messages, retrieving data from databases such as weather and other time-critical data services, summoning assistance from emergency service providers using voice, fax and email messages, receiving alerts and warnings specific to the user's geographic area, and using the same communications device to transmit autonomous monitoring data regarding the vehicle or vessel in which LEO communicator 110 is installed.

LEO communicator 110 includes a personal computing device 112, a satellite data communicator 114, and an antenna 116 according to an exemplary embodiment. Satellite data communicator 114 is coupled to personal computing device 112 and antenna 116 via a hardwired connection or, alternatively, via a “wireless” connection to facilitate data communication.

Satellite data communicator 114 may be further coupled to vessel auxiliary systems 118. Vessel auxiliary systems 118 are systems configured to monitor the status of any of a variety of systems and components associated with the vessel including, but not limited to a shore power coupling detector, a bilge water level sensor, a battery voltage detector, fuel level detector, etc.

LEO communicator 110 may further include an alternative communication system 119 according to an exemplary embodiment. Alternative communication system 119 may be a satellite phone system, a short wave radio system, a cellular system, etc. Alternative communication system 119 may be associated with communication limitations such as proximity to shore and/or communication costs. According to an exemplary embodiment, wherein LEO communicator 110 includes an auxiliary communication system, LEO communicator 110 may be configured to optimize communication based on certain criteria. For example, when LEO communicator 110 is within range of a cellular network, it may be advantageous to provide information services through the cellular system instead of through satellite data communicator 114 to reduce cost and maximize throughput. Once the satellite data communicator is outside of range for the cellular network it can switch the communication type to utilize LEO satellite system 120 or another auxiliary communication system.

Personal computing device 112 may be any type of computer device such as a handheld computing device, a laptop computing device, a desktop computing device, etc. Personal computing device 112 includes a processing unit configured to execute sequences of instructions contained in a memory. More specifically, execution of the sequences of instructions causes the processing unit to perform steps, which are described below with reference to FIGS. 2-5. The instructions may be loaded into a random access memory (RAM) for execution by the processing unit from a read-only memory (ROM), a mass storage device, or some other persistent storage. In other embodiments, hardwired circuitry may be used in place of, or in combination with, software instructions to implement the exemplary embodiments. Thus, the embodiments described herein are not limited to any specific combination of hardware circuitry and software, nor to any particular source for the instructions executed by the computer system.

Satellite data communicator 114 includes a packet radio modem, an application processor, volatile and nonvolatile memory and hardware interfaces for detecting and measuring analog and discrete signals from vessel auxiliary systems 118 according to an exemplary embodiment. According to alternative embodiments, satellite data communicator 114 can include fewer, different, or additional components to implement the functions described herein.

To initiate the transmittal of a message using satellite data communicator 114, personal computing device 112 sends a message to satellite data communicator 114 over a serial data connection. Satellite data communicator 114 receives the message and stores the message in the memory of communicator 114 in a message queue. Alternatively, a message may be generated autonomously by the satellite data communicator 114 on a prescheduled basis or when the application processor in satellite data communicator 114 detects that an alarm condition is present from one of vessel auxiliary systems 118 or from the current position is outside an allowed area. Alternatively, an alarm condition may occur based on the detected position of the vessel. For example, an alarm may be desirable wherein the vessel departs a predefined geographic area. Uses can include defining a zone of use for charter vessels, preventing fishing vessels from entering areas where fishing is prohibited, preventing theft, etc.

When a message is present in the message queue, satellite data communicator is configured to establish a communication channel with an LEO satellite in LEO satellite system 120. To establish a communication channel, satellite data communicator 114 continuously searches a list of defined possible satellite downlink frequencies to initiate contact with a LEO satellite. Upon establishing contact, when a message is in the message queue, satellite data communicator 114 sends a short burst of data to the LEO satellite containing validation information and requesting a time and frequency on which to send the body of the message in the message queue. After satellite data communicator 114 has been validated on the LEO satellite system, the LEO satellite send a reply message to satellite data communicator 114 including time slots and frequencies to transmit the packets of the message.

Upon receiving the time and frequency in a reply message, communicator 114 transmits the message in the message queue in short bursts, which are received by the LEO satellite and relayed to a terrestrial gateway earth station. If there is no terrestrial gateway in view of the LEO satellite at the time of the transmission from communicator 114, the data can be stored in the memory of the LEO satellite and later downloaded to a terrestrial gateway when the gateway comes into view of a satellite. After the LEO system has verified that it has received the entire message error-free, it sends an acknowledgement data packet to the satellite data communicator to terminate the session.

When a communication channel has been established, satellite data communicator 114 locks onto the downlink frequency until the downlink packet error rate exceeds a threshold value, which will occur when the LEO satellite has gone below the local horizon or has moved behind an obstruction. Communicator 114 then begins to search the downlink channel list again to find the next LEO satellite. It is not uncommon to have gaps of five to ten minutes between LEO satellites.

Antenna 116 may be any standard antenna configured to facilitate transmission and reception of data packets over a wireless communication channel. Antenna 116 may be configured to provide transmission and reception from both LEO satellite system 120 and a global positioning satellite (GPS) system 125. GPS system 125 is a system of GPS satellites that circle the earth twice a day in a very precise orbit and transmit signal information to earth. GPS receivers take this information and use triangulation to calculate the exact location of the user.

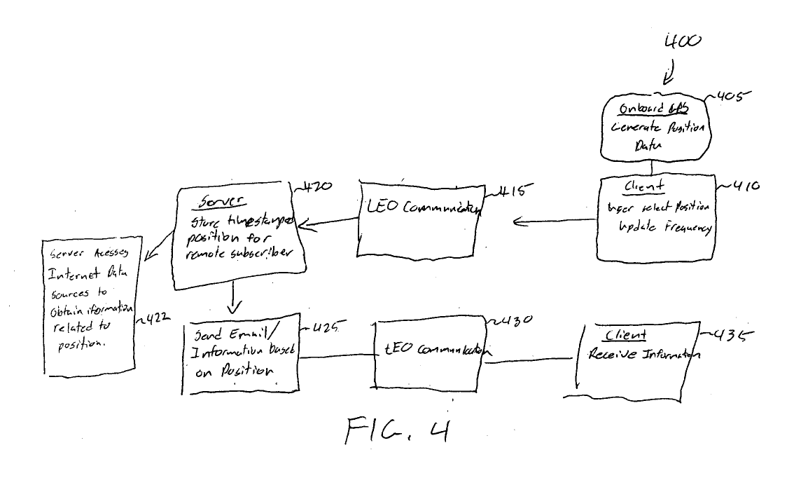

Accordingly, satellite data communicator 114 may further include an internal GPS receiver for determining its position. Alternatively, satellite data communicator 114 may receive position information from an external source (for example, from a GPS receiver that may already be installed in the vessel, vehicle, or aircraft.). As another alternative, satellite data communicator 114 may determine its own position without any GPS device by measuring the Doppler shift in the frequency of the arriving signals from an LEO satellites passing overhead. Through one of these means, satellite data communicator 114 may obtain the current position; this information can be passed to personal computing device 112 or used for computing location-based services, further described below with reference to FIG. 4.

Low earth orbiting (LEO) satellite system 120 is a system of satellites that rotate around the earth in a circular orbit at a constant altitude of a few hundred miles. The orbits are varied such that some of the satellites fly over, or nearly over, the geographic poles, while other orbits are inclined at an angle of approximately 45 degrees to provide more satellite coverage over highly populated areas of the globe. Each revolution takes approximately 100 minutes. The system of satellites is arranged in such a way that, from any point on the surface of the Earth, at any time, one satellite is in a line of sight about 70-90 percent of the time. LEO satellite system 120, in combination with LEO communication system 100, makes it possible for anyone to access the Internet from virtually any point on the planet via a wireless connection using a standard antenna.

LEO satellite system 120 further includes multiple terrestrial gateways, shown in FIG. 1 as groundstation 122. A terrestrial gateway includes gateway antennas configured to track LEO satellites as they pass overhead and send and receive data from the LEO satellites on a dedicated, high bandwidth link. The terrestrial gateways are controlled by a gateway control center, which selects which satellites to track and monitors the health and status of the terrestrial gateways. Each gateway control center has one or more terrestrial gateways connected to it which relay data packets from the satellites to a central message handling software program in the gateway control center. The central message handling program handles the subscriber validation, billing, and storage of messages in transit, and serves as a link to the Internet and all other terrestrial transmission means. Accordingly, LEO satellite system 120 is able to receive messages from LEO communicator 110 and transfer them to LEO application server system 130.

LEO application server system 130 is a computing system configured to send and receive information over the LEO satellite system 120. LEO application server system 130 may also be configured to send and receive information over alternative communication system 119. LEO application server system 130 may be any type of computing system configured to run multiple applications. According to an exemplary embodiment, application server system 130 may include a plurality of computing systems configured to operate cooperatively. Application server system 130 may further include additional components and/or systems to increase processing power, data throughput, robustness, etc.

According to an exemplary embodiment, communication between LEO satellite system 120 and the application server system 130 is done by email. Each type of service request from personal computing device 112 is addressed to a specific email address. For example, weather requests are sent to wx@skymatewireless.com, and monitoring reports and sent to monitor@skymatewireless.com. Application server system 130 monitors these mailboxes and takes action according to the content of the emails received. Application server system 130 applications include server processes for setting up account parameters, acting on weather requests, handling incoming and outgoing email, handling position reports, etc.

LEO application server system 130 may be further configured to communicate with a network through a network communication link. Communication through the network communication link may be implemented using http email. The network can be the Internet, a worldwide network of computer networks that use the TCP/IP network protocols to facilitate data transmission and exchange, or an Intranet, a company-wide network of computer networks using a common communication protocol. In such embodiments, the network can communicate with Hypertext Markup Language (HTML) web pages or any other type of presentation format, such as, formats used in WAP phones, personal digital assistants (PDAs), or any other communication device. In alternative embodiments, the network is any type of network, such as, a virtual private network, a wide area network (WAN), a local area network (LAN), a wireless network, or extranet.

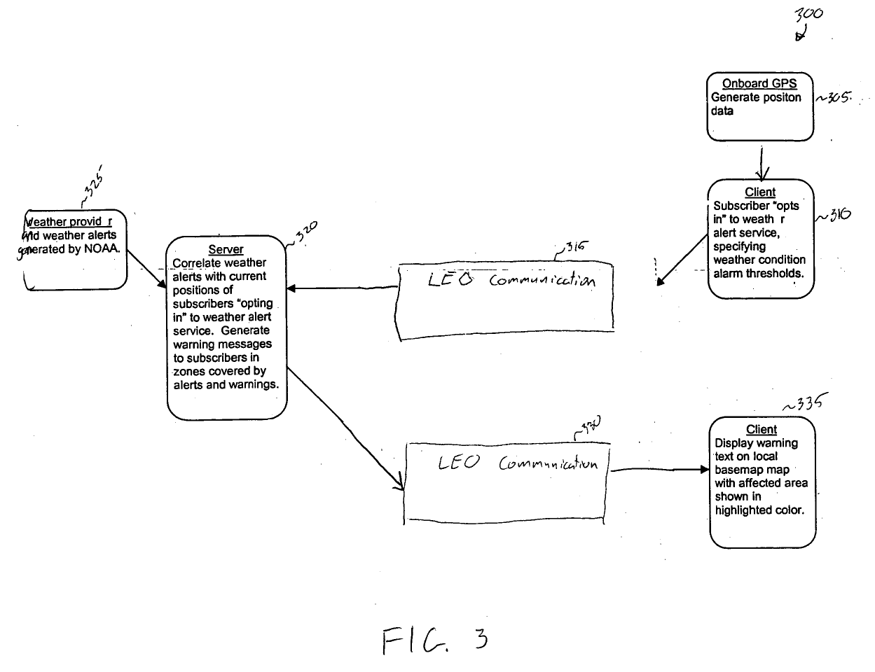

Through the network communication link, LEO application server system 130 may be configured to send and receive data with a variety of information sources. An example of information sources can include a user email account 140, general Internet data sources 150, and a voice and facsimile server 160. Utilization of the information sources will be further described below with reference to FIGS. 3-5.

Referring now to FIG. 2A, FIG. 2A is a flowchart 200 illustrating a method for sending information using LEO communication system 100 according to an exemplary embodiment. Specifically, flowchart 200 illustrates transferring information from the user of LEO communicator 110 to application server system 130.

In a first step 205, a user initiates a communication using personal computing device 112. Communication can include sending an email, requesting information, requesting services, etc. as will be further described below with reference to FIGS. 3-5.

According to an exemplary embodiment, personal computing device 112 may include an interface application configured to provide an easy to use interface to the features and services available using LEO communication system 100. The interface application may include a user interface to facilitate entry and/or display of information. The user interface may be configured based on the information services that are available using LEO communication system 100. According to an exemplary embodiment, the user can initiate communication using the interface application or a third party application coupled to the interface application.

According to an exemplary embodiment, in step 205, the interface application may be configured to receive data from user input, perform data manipulation operations to convert the data into optimized data packets, and transfer the data to satellite data communicator 114. Data manipulation operations to create optimized data packets can include filtering, creating and reassembling data packets, compressing and decompressing the data, encrypting and decrypting the data, storing data, attaching and removing headers, error detection handling, etc. The data manipulation operations may be performed directly by the interface application or indirectly by calling a third party application. For example, according to an exemplary embodiment, the interface application may call a third party application to facilitate data compression, such as WinZip by WinZip Computing, Inc. of Mansfield, Conn.

Data handling operations are used to reduce the expense of transmitting information using LEO communication system 100. Costs for the use of LEO satellite systems are proportional to the amount of data transmitted and received. In addition, the costs per byte of data are much higher than terrestrial and other satellite systems. Therefore, it is desirable to make the most efficient use of the transmitted data. Follow data handling operations, the message is converted into a binary file and further converted into discrete data packets.

Following creation of the data packets, data packets are received by a satellite data communicator 114 in a step 210. Also in step 210, satellite data communicator 114 stores the data packets in an internal memory until satellite data communicator 114 determines that an LEO satellite is within line of sight such that transmission can be accomplished. Upon detection of an available LEO satellite, the packet is transmitted to the LEO satellite.

The data packets are received by LEO satellite system 120 in a step 215 and routed to a gateway control center. At the gateway control center, the data packets can be reconverted into an SMTP email and forwarded to LEO application server system 130 through the Internet.

Upon reception of the SMTP email at LEO application server system 130 in a step 220, the email can be processed by LEO application server system 130 to determine the action to be taken based on receipt of the email. During processing, server system 130 uncompresses and decrypts the message, then “unpacks” the resulting text file into a standard SMTP email that can be further processed. For example, for an ordinary email communication, the email is forwarded to the intended recipient by LEO application server system 130. The intended recipient receives the email in a step 225.

Referring now to FIG. 2B, FIG. 2B is a flowchart 250 illustrating a method for receiving information using LEO communication system 100 according to an exemplary embodiment. Specifically, flowchart 250 illustrates transferring information from an external source via LEO application server system 130 to the user of LEO communicator 110. In a step 255, the email is sent by the sender using standard email service. The email is received by LEO application server system 130 in a step 260. In step 260, the email is converted into a binary attachment and forwarded to LEO satellite system 120 via the Internet.

In a step 265, the email is received by a groundstation terminal 122 of LEO satellite system 120. The email is filtered, compressed, encrypted, converted into packets, etc. as detailed above in relation to satellite data communicator 114. The email is then relayed to LEO satellite system 120. According to an exemplary embodiment, LEO satellite system 120 does not transmit the full message initially. A first step is implemented to send out a short packet which announces to LEO communicator 110 that a message is ready to be transmitted. This short packet is first transmitted using the LEO satellite which is closest to the last known position of LEO communicator 110. If there is no answer after a set time period, the packet is broadcast on all LEO satellites. If still no answer, the transmitting process is repeated a few minutes later, then a few hours later. The transmitting process continues with longer and longer time intervals for five days. After five days, the message is declared undeliverable and an error message is sent to the originator of the message. However, where communicator 114 responds to the packet, the gateway control center software then begins transmission of the full message including all of the data packets.

When an LEO satellite is within line of sight of LEO communicator 110, the email is broadcast from the LEO satellite to LEO communicator 110 in a step 270. Communicator 110 actively monitors the downlink from LEO satellite system 120, looking for its own address in every packet. When communicator 110 detects a packet that is addressed to it, the software takes the appropriate action. According to an exemplary embodiment, the email message is received through satellite data communicator 114 and stored on personal computing device 112. Upon receiving the email message, satellite data communicator 114 can provide an indicia indicating that a message has been received. For example, an LED can be activated to indicate that an email message has been received. Upon reception, the email message is then reconverted into an email and displayed to the user in a step 275.

Various types of communication may be implemented using the above described methods. Communications can include personal communication, information requests, service requests, etc. According to an exemplary embodiment, a user may configure a user profile stored on application server system 130 to specify the type of information that can be transferred, the frequency of transfers, etc. For example, a user may wish to periodically receive sports scores, news, and/or stock quotes. Accordingly the user may configure the profile such that sports scores, stock quotes, and news headlines are sent to communicator 110 on a daily basis. The user goes to a web page to specify his preferences for his desired teams, stocks, news topics. The system sends an email to the user every day with a summary of the daily news.

Further, application server system 130 may be configured to periodically transmit email received in user email account 140. Anti-SPAM screening features may be implemented specifying a keyword that must be present in the subject field of the email in order for the message to be forwarded over the satellite link. To prevent transfer of large emails, for emails with attachments, only the text portion is forwarded; the full email with attachment is stored on the email server for later retrieval using a higher bandwidth system in a hybrid fashion.

Additionally, maritime vessels and other vehicles often include a variety of systems for monitoring the well-being of the vessel or vehicle. For example, a maritime vessel may include sensors for monitoring bilge levels, battery voltage, fuel level, and the status of a shore power connection. If any of these sensors detect a problem, a warning can be communicated to the user. However, it some instances, the user may be remotely located or it may be necessary to communicate the information to an external entity. Examples can include while the user is away from the vessel while it is docked or stored, a problem may be communicated to a repair service provider, or an emergency reported to emergency services in the event of a serious problem.

Advantageously, satellite data communicator 114 includes interfaces to continuously monitor the sensors. Advantageously, satellite data communicator 114 is configured to monitor the sensors using only a very small amount of power (about one milliwatt). Accordingly, the sensor monitoring can be implemented for a long period of time using a relatively small battery. Satellite data communicator 114 may be configured to receive the status information and send a communication containing the received status information.

Further, LEO communicator 110 can be configured to facilitate a request for emergency services in the event of a serious problem. According to an exemplary embodiment, the user can press a single button to initiate a distress service call. The distress service call will be sent in an email using LEO communication system 100. Upon receipt of the message, LEO application server system 130 may be configured to send an automated series of messages containing the details of the vessel, contact information, and the current position to initiate an emergency response. According to an exemplary embodiment, the LEO application server system 130 can forward the information to an attendant. The attendant will relay the message to the appropriate emergency service provider, such as the US Coast Guard or towing agency specified by the user.

Referring now to FIG. 3, FIG. 3 is a flowchart 300 illustrating a method of receiving updated text weather information based on current position using LEO communication system 100 according to an exemplary embodiment. Customized, location-specific weather forecasts can be retrieved using LEO communication system 100. The weather forecast can be for either a fixed location or along a planned route. Alternatively, a user's GPS location may be used to automatically specify the location for the weather reports.

In a step 305, where the user is using a GPS unit to determine current position, the user can determine their current position in a step 305. The current position can be determined by the user independently by reading the GPS unit or the GPS unit can be attached to personal computing device 112 or satellite data communicator 114 such that current position information is automatically available.

In a step 310, the user may select a desired forecast type using a menu guided selection process within the interface application described with reference to FIG. 2. Forecast types can include air temperature forecast, sea surface temperature forecasts, wind forecasts, etc. The user may further define other parameters such as duration, range, or alternative location. Further, when the user is not using a GPS unit to specify the target location for the forecast of desire a forecast for an alternative, possibly future, location, the user may manually enter a map zone or longitude and latitude for the forecast location.

In a step 315, an email is composed using the method described above with reference to FIG. 2 to communicate the weather forecast request to LEO application server system 130. LEO application server system 130 is configured to receive the email in a step 320 and recognize the email as a request for a weather forecast. According to an exemplary embodiment, the message may be sent to a special email address “wx@skymatewireless.com” Application server system 130 is configured to periodically scan the inbox of this email account and perform actions based upon the messages in the inbox. Application server system 130 translates the request for a weather forecast and accesses an Internet data source 150 to obtain the requested information. For example, for a weather forecast request, LEO application server system 130 may be configured to access an Internet source for text weather reports such as http://www.bouyweather.com, http://www.noaa.gov, or any other source.

In a step 325, LEO application server system 130 retrieves the requested information from Internet data source 150. LEO application server system 130 may be configured to recognize and strip away extraneous information from the obtained text information. The information can then emailed to the user using LEO communication system 100 using the communication method as described above with reference to FIG. 2 in a step 330. The information is displayed to the user in a step 335.

Alternatively, in step 310, the user may request a graphical weather reports as opposed to a simple text weather report. However, a reasonably sized, full color graphical weather report over a map is a large file that may exceed a reasonable message size. Accordingly, in order to reduce transmission expense, a base map may stored locally on personal computing device 112, and only the actual dynamic weather images may be transmitted over the air. When the dynamic weather images are received by LEO communicator 110, the full image is reconstituted by overlaying the data over a stored base map. The base maps may be updated by portable storage such a CD-ROM or wirelessly whenever a low-cost data channel is available, i.e. through a cellular network.

Alternatively, the user may desire to control the geographic range covered by the graphical weather report and may also want to specify the desired image quality since both of these factors can affect the message size and therefore cost. These inputs may be included as predefined values or customized for each request. The inputs are included in the weather request.

Referring now to FIG. 4, FIG. 4 is a flowchart illustrating a method for automatically providing position reports using LEO communication system 100 according to an exemplary embodiment. The user of LEO communication system 100 may desire to periodically report a current position for storage on LEO application server system 130. Stored position information may then be accessed by friends or family wanting to know the user's current position, utilized to determine whether there are any weather alerts based on the user's position, utilized in the event of an emergency to determine last know position, etc.

As described above with reference to FIG. 3, LEO communicator 110 may include or be coupled to a GPS unit to obtain the current position information for the user/vessel in a step 405. The position information can be periodically transmitted by email based on user defined preferences. For example, the user can specify that a position report should be broadcast either hourly, 4 times daily, daily, etc. The position information transmitted may further include a timestamp value to indicate the time that the user was at the position. The position information can be broadcast over LEO communication system 100 in a step 410.

LEO application server system 130 receives and stores the updated position reports in a step 415. The position information can be stored in a database containing all stored position reports for that specific user in a step 420. Preferably, the database should be searchable according to various criteria.

According to an exemplary embodiment, LEO application server system 130 can be configured to enable a person to access LEO application server system 130 over the Internet to obtain user position information. The user position information can be overlaid on a graphical map to provide a position report. For example, the position is embedded in an internet URL which can be clicked on to display the boat's position on a full-color map that is called up from the server specified in the URL. The position information can further include historical position information to show the user's course to date. According to an exemplary embodiment, access to user position information may be access controlled, such as through a password. The internet URL can also be sent to an email address list specified by the user. This way, the interested parties can receive the position reports almost immediately after they are sent by communicator 114.

Further, the user can subscribe to a weather alert service using the user defined preferences described above. The user can set the preferences specifying weather condition alarm thresholds. For example, the user can request notification whenever current position reports indicate that wind may exceed a certain speed, whenever waves may exceed a certain height, or whenever waves coming from a certain direction exceed a certain height that may adversely affect an anchorage in a specific harbor, etc.

LEO application server system 130 may further be configured to determine whether any weather alert emergencies are applicable based on the user's current position. LEO application server system 130 may further be configured to calculate a future position based on reported position information and future position may be used to determine weather alerts that may be applicable to the user in the future.

A user's current position may also be used to determine information that may be applicable to a user. Examples may include a calendar of local events, news alerts, available local services, etc. For example, the information may include but is not limited to local fuel prices, available lodging services, travel warnings, weather warnings, etc.

When indicated by the content of the email, LEO application server system 130 accesses at least one of Internet data sources 150 in a step 422 to obtain requested or relevant information. If LEO application server system 130 determines that information should be transmitted to the user email in a step 425 based on the position report, LEO application server system 130 transmits the information in an email in a step 430 using the method described above with reference to FIG. 2 and received in a step 435.

Yet further, position reporting can be used to implement boat to boat position sharing. Many boaters enjoy their boating experience in loosely or formally defined groups such as clubs, associations, races, rallies, and regattas. This feature will allow boaters having a LEO communicator 110 to share position reports in real time to enhance the enjoyment of the communal boating experience.

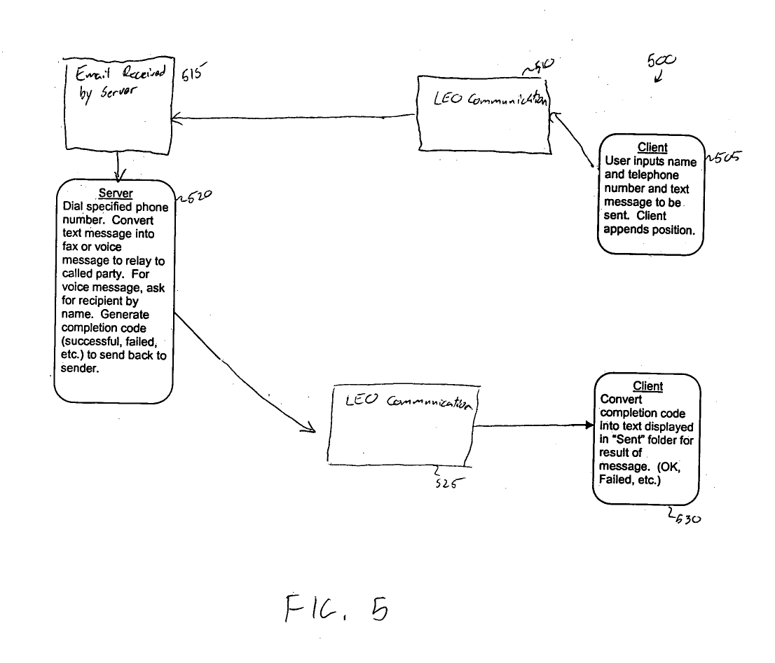

In some cases, a user may desire to communicate with a person or entity that does not have access to email. For example, a user may want to make a slip reservation, obtain towing service, locate a replacement part, etc. at an approaching port in a remote area. Referring now to FIG. 5, FIG. 5 is a flowchart 500 illustrating a method for transmitting a voice or facsimile message to a remote user using LEO communication system 100 according to an exemplary embodiment. The user may generate an email message containing the message to be sent by facsimile or voice. The user specifies the phone number and the text message. The email will the be transmitted using LEO communicator 110 and LEO satellite system 120 as described above with reference to FIG. 3 in a step 510. LEO application server system 130 receives the email and extracts the message to be sent by facsimile or voice by voice and facsimile server 160 in a step 515. The message can then be converted into an appropriate format in a step 520. For example, for a facsimile message, the message can be used to compose a facsimile with appropriate headers and information retrieved from a user specific data file. For a voice message, the message can be used as input in a text-to-voice conversion system or simply read into a recorder by a technician. The conversion can be implemented using internal or third-party applications in voice and facsimile server 160. The user can receive a confirmation of successful delivery to the end recipient of the fax or voice message via return email.

Following transmission of the message, a confirmation code can be sent to the user using standard LEO communication as described above with reference to FIG. 2 in a step 525. The message is received by the client in a step 530.

Advantageously, LEO communication system 100 takes the essential advantages of low earth orbit satellite terminals, namely portability, low initial cost, and low power requirements, and uses the above described techniques to compensate for the disadvantages of such systems to provide services that are not available in any other way. Further, services can be provided automatically such that the user does not need to spend their time with mundane communications tasks such as telling people where they are or checking an email box. The personal safety of the user and the vessel or vehicle is enhanced because the low earth orbit satellite system has near total coverage of the earth's service, so that distress calls are facilitated.

While the exemplary embodiments illustrated in the FIGS. and described above are presently preferred, it should be understood that these embodiments are offered by way of example only. Accordingly, the present invention is not limited to a particular embodiment, but extends to various modifications that nevertheless fall within the scope of the appended claims.

1. A method for sending email from a remote location, comprising:
generating an electronic mail message using a personal computing device;
transferring the electronic mail to a satellite data communicator configured to provide communication with a low earth orbiting satellite; and
sending the electronic message to a low earth orbiting satellite using the satellite data communicator and an antenna coupled to the satellite data communicator.

2. The method of claim 1, wherein the electronic mail includes a request for weather information.

3. The method of claim 2, wherein the method further includes receiving a responsive email containing text weather information.

4. The method of claim 2, wherein the method further includes receiving a responsive email containing graphical weather information.

5. The method of claim 4, wherein the graphical weather information contains dynamic weather information and not a map.

6. The method of claim 5, further including the step of applying the received dynamic weather information to a map stored on the personal computing device.

7. The method of claim 1, wherein the electronic message includes a text message to be converted into a voice message.

8. The method of claim 1, wherein the electronic message includes sensor data received from sensors on a transportation mode.

9. The method of claim 8, wherein the personal computing device is configured to generate and transmit the electronic mail on a periodic basis.

10. The method of claim 1, wherein the electronic message includes a position information obtained from a global positioning satellite.

11. The method of claim 10, wherein the personal computing device is configured to generate and transmit the electronic mail on a periodic basis.

12. A system for providing information to a user in a remote location, the system comprising:
a communicator, the communicator including
a personal computing device;
a satellite data communicator; and
an antenna; and
an application server system, wherein the application server system is configured to send and receive email with the communicator through a low earth orbit satellite system.

13. The system of claim 12, wherein the communicator is coupled to sensors on a transportation mode.

14. The system of claim 13, wherein the communicator is configured to transmit an electronic mail containing information received from the sensors to the application server system.

15. The system of claim 14, wherein the electronic mail is transmitted periodically.

16. The system of claim 14, wherein the electronic mail is transmitted based on the information received from the sensors.

17. The system of claim 12, wherein the application server system is configured to perform an action based on the contents of the electronic mail.

18. The system of claim 17, wherein the action includes converting at least a portion of the electronic message into a voice message and transmitting the voice message.

19. The system of claim 17, wherein the action includes initiating an emergency response.

20. The system of claim 17, wherein the action includes processing position information included in the electronic mail.

21. The system of claim 20, wherein processing position information includes forwarding position information in a generated electronic mail to a pre-selected group.

22. The system of claim 12, wherein the application server system is configured to automatically compose and transmit an electronic mail to the communicator based upon user defined preferences.

23. The system of claim 22, wherein the user defined preferences include a selection of at least one of a news topic, a sports team, and a stock.

24. The system of claim 12, wherein the communicator is configured to display an indicia to indicate that an electronic mail has been received from the application server system.

25. A system for providing information to a user in a remote location, the system comprising:
a communicator means configured to transmit and receive electronic mail over a low-earth orbiting satellite system from a remote location; and
an application server means configured to perform an action based upon the contents of an electronic mail message received from the communicator means.

26. The system of claim 25, wherein the communicator means is coupled to sensors on a maritime vessel.

27. The system of claim 26, wherein the communicator means is configured to transmit an electronic mail containing information received from the sensors to the application server means.

28. The system of claim 27, wherein the electronic mail is transmitted according to a defined period.

29. The system of claim 27, wherein the electronic mail is transmitted based on the information received from the sensors.

30. The system of claim 25, wherein the action includes converting at least a portion of the electronic message into a voice message and transmitting the voice message.

31. The system of claim 25, wherein the action includes initiating an emergency response.

32. The system of claim 25, wherein the action includes processing position information included in the electronic mail.

33. The system of claim 32, wherein processing position information includes forwarding the position information included in the electronic mail in a generated electronic mail.

34. The system of claim 25, wherein the application server means is configured to automatically compose and transmit an electronic mail to the communicator means based upon user defined preferences.

35. The system of claim 34, wherein the user defined preferences include a selection of at least one of a news topic, a sports team, and a stock.

36. The system of claim 25, wherein the communicator means is configured to display an indicia to indicate that an electronic mail has been received from the application server means.
